(19) United States
(12) Patent Application Publication
(10) Pub. No.: US 2012/0047110 A1
(43) Pub. Date: Feb. 23, 2012

(54) System and Method for Automatic Data Defragmentation When Restoring a Disk

(76) Inventors: Jeffrey Brunet, Richmond Hill (CA); Yousuf Chowdhary, Maple (CA); Zelik Levit, Thornhill (CA)

(21) Appl. No.: 13/209,811

(22) Filed: Aug. 15, 2011

Related U.S. Application Data
(60) Provisional application No. 61/401,689, filed on Aug. 18, 2010.

(51) Int. Cl. G06F 7/00

(52) U.S. Cl. 707/640; 707/E17.005; 707/E17.007

(57) ABSTRACT

A method is described to restore backed-up data to a data source such that the data are automatically defragmented. Defragmentation is accomplished during the restore operation by identifying data blocks belonging to discrete data files and copying those data blocks to the target data source such that all data blocks for any given file are written to contiguous sectors on the target data source.

### CROSS-REFERENCE TO RELATED APPLICATIONS

This application claims priority of U.S. Provisional Patent Application No. 61/401,689, entitled “System and Method for Automatic Data Defragmentation When Restoring a Disk,” filed Aug. 18, 2010, the disclosure of which is incorporated herein by reference.

### BACKGROUND

1. Field of the Invention

The field of invention is generally data backup and restoration, and in particular, issues of disk fragmentation.

2. Description of the Prior Art

Non-volatile memory devices such as hard disk drives in a data source (e.g., a personal computer) are designed to store data in “allocation units,” which represent the smallest-sized block of storage that can be set aside to store a particular data chunk. Hard disk drives and other non-volatile memory devices are divided into a number of fixed data allocation units or “sectors.” A minimum of one sector is required to store a chunk of data, even if the given data chunk is smaller than the sector. If a given data chunk is larger than a single sector, two or more sectors are allocated to hold the data chunk.

Those skilled in the art will appreciate that the nature of non-volatile memory devices such as hard disk drives, and specifically the iterative writing to and deleting of files from these devices often leads to a situation known as “fragmentation,” in which fragments of data files become scattered (or fragmented) across the non-volatile memory. Fragmentation occurs when the operating system cannot allocate enough contiguous space to store a file as a complete unit, and instead positions pieces of that file in gaps between other stored files. These gaps of non-allocated space (i.e., “free space”) are created as files are added to or removed from the digital storage device, or changed in size. For example, a formerly stored file may be deleted, thereby freeing up sectors previously containing that file, or an individual file may not fully occupy the entire sector(s) allocated to it. Larger files, greater numbers of files, and a storage device approaching capacity all contribute to fragmentation by leaving only scattered regions of free space available for allocation. As the operating system fills incoming allocation requests, a single file may be fragmented such that portions of that file are stored to non-contiguous sectors of free space on the non-volatile memory device.

A solid-state device (e.g., flash memory) likewise requires defragmentation. As with hard disk drives, when files outgrow initially allocated contiguous space, the operating system must allocate non-contiguous blocks for storage, and the files become fragmented. Flash drive data are organized in data blocks (usually 128K or 256K in size) such that the contents of the entire block of data must be read, erased and then re-written even to change a single byte of data. Thus, files take longer to update as fragmentation increases, and caching of the file may even become impossible if the fragmented file occupies hundreds of non-contiguous clusters.

The consequences of fragmented data files include slower file access (because of increased seek time and rotational delays of read/write heads) and increased overhead (to manage additional locations for a single file). If a non-volatile memory device becomes highly fragmented (i.e., multiple files are fragmented), both the storage capacity and performance of the non-volatile memory device decrease.

One way to maximize non-volatile memory device performance is to store all fragments of each data file in contiguous sectors of the device. As is known in the art, defragmentation software attempts to do just that. And, generally speaking, non-volatile memory device performance is better after defragmentation because the device does not have to read data from or write data to several physically disparate locations on the non—volatile memory device.

Defragmentation can be achieved by identifying noncontiguous fragments of data stored on the non-volatile memory device and physically reorganizing the contents of the non-volatile memory device to store these noncontiguous fragments contiguously with other fragments of the same file. When the defragmentation process is complete, each individual file is stored in one contiguous sequence of sectors. This process optimizes read/write times by minimizing non-volatile memory device head travel time and maximizing the data transfer rate. As a result, defragmentation reduces data access time and allows non-volatile memory to be used more efficiently.

Although software applications exist that can defragment a non-volatile memory device, users must manually start these applications. Some users may be ignorant of the problems caused by fragmentation, while others may understand the problems associated with fragmentation, but may not defragment media on a regular basis. Others may be using computer systems controlled by an administrator such that the user is not permitted control access to software that can defragment non-volatile memory devices. Still other users are reluctant to defragment their non-volatile memory devices because the defragmentation process slows down the computer by taking resources away from other running applications. One possible solution is to permit a defragmentation application to run at a time when the non-volatile memory device is not being used actively (e.g., overnight), although this approach may be inconvenient, especially as it requires that the non-volatile memory device remain turned on during this time.

When a data source is backed up using a disk imaging method, the disk image is a bit-by-bit representation of the original non-volatile memory. Disk images are most often made for backup and restore purposes, so that data can be recovered in the event of a disaster such as accidental deletion, hard disk drive failure, data corruption, virus attack, etc. Known methods and systems for restoring a disk image perpetuate disk fragmentation by writing the backed-up data bit-by-bit to exactly the same address on the non-volatile memory device from which they came when the image was created. Thus, when a non-volatile memory device fails and its data are restored using the backed-up disk image, the restored non-volatile memory device is necessarily as fragmented as before failure.

A common myth is that defragmentation can be achieved by backing up data file-by-file from a computing device to a storage medium, formatting (or re-formatting) the computing device, and then restoring the backed-up data from the storage medium to the computing device. While it is true that the operating system attempts to allocate space and write file blocks contiguously during the restore of a file-by-file backup, several factors will affect whether or to what degree file blocks are contiguously restored, including, for example, whether the computing device was (re)formatted before the restore, whether files are being overwritten, and whether the disk drive is near capacity. Furthermore, the folders will likely not be organized in a contiguous manner because of the way they are created. Specifically, the operating system initially allocates a small amount of space (usually one cluster) for the folder, and then allocates additional clusters as necessary as files are added to a folder, During the restore process, folders are again created with minimal space allocated. As files from the backup are restored into the folders, the folders grow and need additional space allocated. As the restore proceeds, the folders outgrow the allocated space, and the operating system must allocate non-contiguous space for additional files (or for additional data from single large files) in a folder, thereby inducing fragmentation into the restored data. (http://www.wizcode.com/articles/comments/flash_memory_fragmentation_myths_and_fa cts/).

### SUMMARY

In one embodiment is provided a method for defragmenting data files being restored to a data source from a set of backup data stored on a storage medium, the method comprising: (a) launching on the data source a stripped down operating system stored on the storage medium; (b) running on the data source a data restore application; (c) identifying a data file of the set of backup data stored on the storage medium using the data restore application running on the data source; (d) allocating contiguous storage space on the data source using the stripped down operating system launched on the data source; (e) copying the identified data file of the set of backup data to the allocated contiguous storage space on the data source; and (f) repeating steps (a), (b), and (c) for any other data files of the set of backup data.

in another embodiment, the method additionally comprises before the step of launching a stripped-down operating system: (a) identifying data files on the data source using a data file backup application running on the data source, and copying the identified data files from the data source to the storage medium; (b) identifying a master boot record on the data source using the data file backup application running on the data source, and copying the identified master boot record from the data source to the storage medium; (c) identifying metadata on the data source using the data file backup application running on the data source, and copying the identified metadata from the data source to the storage medium; (d) identifying disk geometry data on the data source using the data file backup application running on the data source, and copying the identified geometry data from the data source to the storage medium; and (e) identifying bootstrap data on the data source using the data file backup application running on the data source, and copying the identified bootstrap data from the data source to the storage medium.

In yet another embodiment is provided a method for defragmenting data files being restored to a data source from a set of backup data stored on a storage medium, the method comprising: (a) running on the data source a data restore application; (b) identifying a master boot record from the set of backup data stored on the storage medium using the data file restore application running on the data source, and copying the identified master boot record from the storage medium to the data source; (c) identifying metadata from the set of backup data stored on the storage medium using the data file restore application running on the data source, and copying the identified metadata from the storage medium to the data source; (d) identifying disk geometry data from the set of backup data stored on the storage medium using the data file restore application running on the data source, and copying the identified geometry data from the storage medium to the data source; (e) identifying bootstrap data from the set of backup data stored on the storage medium using the data file restore application running on the data source, and copying the identified bootstrap data from the storage medium to the data source; (f) identifying a data file of the set of backup data stored on the storage medium using the data restore application running on the data source; (g) allocating contiguous storage space on the data source; (h) copying the identified data file of the set of backup data to the allocated contiguous storage space on the data source; and (i) repeating steps (f), (g), and (h) for any other data files of the set of backup data.

In yet another embodiment is provided anon-transitory computer readable medium having stored thereupon computing instructions comprising: (a) a code segment to launch on the data source a stripped down operating system stored on the storage medium; (b) a code segment to run on the data source a data restore application; (c) a code segment to identify a data file of the set of backup data stored on the storage medium using the data restore application running on the data source; (d) a code segment to allocate contiguous storage space on the data source using the stripped down operating system launched on the data source; (e) a code segment to copy the identified data file of the set of backup data to the allocated contiguous storage space on the data source; and (f) a code segment to repeat steps (c), (d), and (e) for any other data files of the set of backup data.

In another embodiment, the non-transitory computer readable medium additionally comprises: (a) a code segment to identify a master boot record from the set of backup data stored on the storage medium using the data file restore application running on the data source, and a code segment to copy the identified master boot record from the storage medium to the data source; (b) a code segment to identify metadata from the set of backup data stored on the storage medium using the data file restore application running on the data source, and a code segment to copy the identified metadata from the storage medium to the data source; (c) a code segment to identify disk geometry data from the set of backup data stored on the storage medium using the data file restore application running on the data source, and a code segment to copy the identified geometry data from the storage medium to the data source; and (d) a code segment to identify bootstrap data from the set of backup data stored on the storage medium using the data file restore application running on the data source, and a code segment to copy the identified bootstrap data from the storage medium to the data source.

In yet another embodiment, the non-transitory computer readable medium comprises: (a) a code segment to run on the data source a data restore application; (b) a code segment to identify a master boot record from the set of backup data stored on the storage medium using the data file restore application running on the data source, and to copy the identified master boot record from the storage medium to the data source; (c) a code segment to identify metadata from the set of backup data stored on the storage medium using the data file restore application running on the data source, and to copy the identified metadata from the storage medium to the data source; (d) a code segment to identify disk geometry data from the set of backup data stored on the storage medium using the data file restore application running on the data source, and to copy the identified geometry data from the storage medium to the data source; (e) a code segment to identify bootstrap data from the set of backup data stored on the storage medium using the data file restore application running on the data source, and to copy the identified bootstrap data from the storage medium to the data source; (f) a code segment to identify a data file of the set of backup data stored on the storage medium using the data restore application running on the data source; (g) a code segment to allocate contiguous storage space on the data source; (h) a code segment to copy the identified data file of the set of backup data to the allocated contiguous storage space on the data source; and (i) a code segment to repeat steps (f), (g), and (h) for any other data files of the set of backup data.

### BRIEF DESCRIPTION OF THE VARIOUS VIEWS OF THE DRAWING

FIG. 1 is a block diagram of the data backup and data restore processes according to one embodiment.

FIG. 2 is an exemplary process flow of the data backup and data restore according to one embodiment.

FIG. 3 is an exemplary process flow for automatic data defragmentation during backup of data from a data source to a storage medium.

FIG. 4 is an exemplary process flow for automatic data defragmentation during data restore from a storage medium to a data source.

### DETAILED DESCRIPTION

The operating system of a data source typically incorporates a file system to facilitate user access to the data files stored on the data source. The file system provides a method of storing, organizing, and accessing the data files. In some implementations, the file system is responsible for organizing physical sectors of the underlying data storage device (e.g. a hard disk drive), and managing the data structure elements that these sectors represent (i.e., files and folders) by keeping track of which sectors contain which files and which sectors are free space (i.e., not in use). File systems typically have directories which may contain files, sub-directories, or both. The file system may also include intermediate data structure elements containing data about data files. This intermediate data or “data about data” is called metadata by those of skill in the art. Metadata may contain information such as file name, file path, file size, date created, date modified, author and permissions amongst other information. The metadata are typically stored along with the respective data files (“embedded”, or “internal” metadata), but may be stored separately from their respectively data files (“detached”, or “external” metadata).

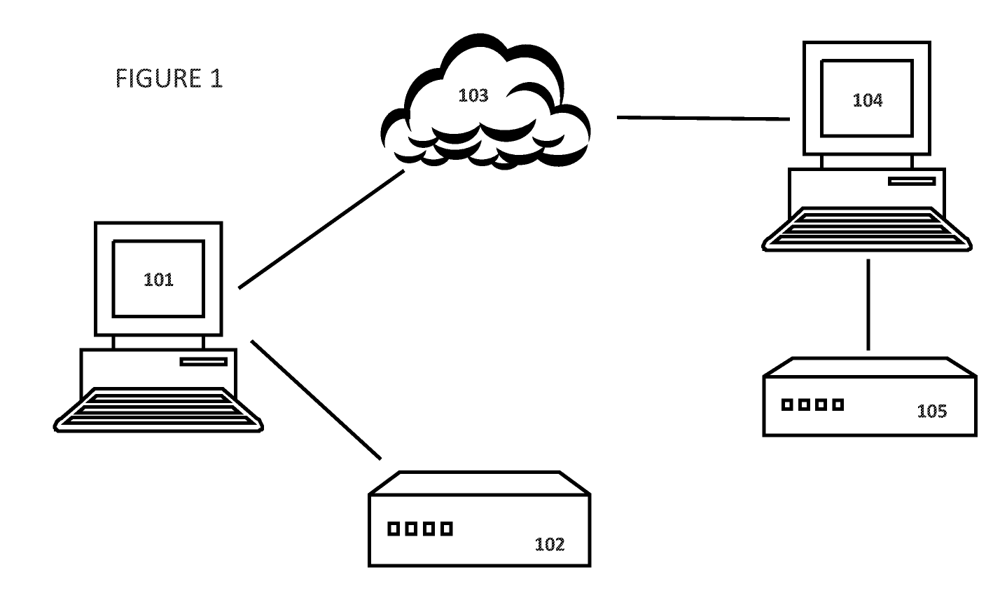

FIG. 1 is a block diagram of systems and methods as described herein to backup digital data from a data source 101 to a storage medium 102 and to restore backed-up digital data from storage medium 102 to data source 101 while automatically (without user input) defragmenting the stored data during backup or restoration of the data. The systems and methods described herein can be applied to restore backed-tip data to a data source following disk failure, or to restore backed-up data to anew data source.

The automatic data defragmentation process comprises a sequence of procedures designed to optimize file arrangement and maximize free space on a target data source. In particular, the method defragments backed-up data as it is copied from an original data source or written to a target disk drive in order to improve performance and to increase computer system efficiency.

Data source 101 is preferably a personal computer with a set of electronic data files stored in non-volatile memory and running an operating system such as the Windows XP operating system, but may be any of a number of different computing systems, including, without limitation, a home personal computer (PC), a corporate PC, a server, a laptop, an Apple Inc. Macintosh computer, a sa-top box, a Netbook, a cellular phone, a personal digital assistant (PDA), a smartphone (e.g., iPhone, Blackberry, etc.), an electronic tablet (e.g., iPad, Android, etc.), an e-book reader (e.g., Kindle, Nook, etc.), a personal video recorder (PVR), a solid-state medium, an optical device, or a hard disk drive. Data source 101 may operate with any number of different operating systems, including without limitation, any variants of the Microsoft Windows family, the Apple Inc. MacOS family, any variants of Linux or Unix, PalmOS, or such operating system for such devices available in the market today or the ones that will become available as a result of the advancements made in such industries.

Data source 101 can be backed up to and restored from any suitable storage medium adapted to store digital information, according to the needs of a situation. Storage medium 102 as referred to herein and especially in the preferred embodiment is an electronic device that is capable of backing up data from a data source. Storage medium 102 may be either hardware (wired or wireless) or media bundled with software that is purpose-built for a specific function, and may use any of a number of different types of memory or media for the storage. For example and without limitation, storage medium 102 may be an external drive (e.g., without limitation, a hard disk drive or another partition of a hard disk drive of data source 101, a device which holds a storage device (e.g., a Compact Disc (CD), a Digital Versatile Disc (DVD), or any other optical drive), other integrated memory such as Flash Memory (USB Key), a secure digital (SD) card, compact flash (CF) card, or any similar storage medium attached through a network 103 (e.g., a local area network, an intranet, or the Internet), such as for example, a server 104 or a hard disk drive 105 attached to server 104. As such, digital data may likewise be stored to and restored from a remote location.

it is to be understood that data from one data source 101 (“original data source”) backed up to one storage medium 102 may be restored to the same or another data source 101 (“target data source”), as for example, if the original data source has suffered a catastrophic failure. In other words, original data source 101 may or may not be the same as target data source 101.

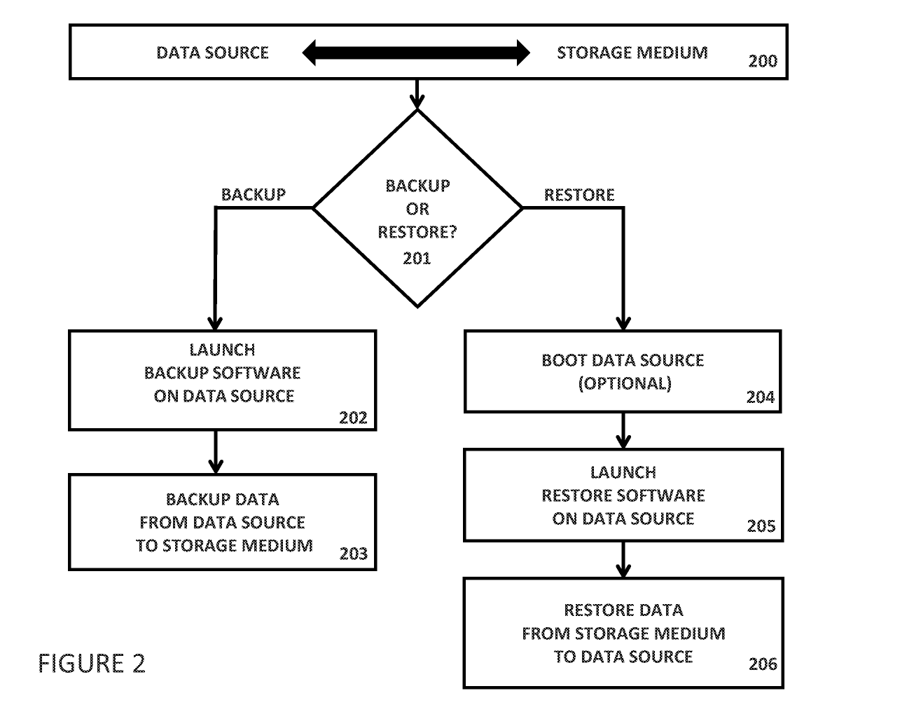

An exemplary flow chart showing data backup and restore processes is presented in FIG. 2. As initial step 200 in both the data backup and data restore processes, storage medium 102 is connected to data source 101. The connection for the data transfer is preferably a USB connection, although one of skill in the art will recognize that other types of connections known in the art such as, without limitation, FireWire, Ethernet, or wireless connections will also work.

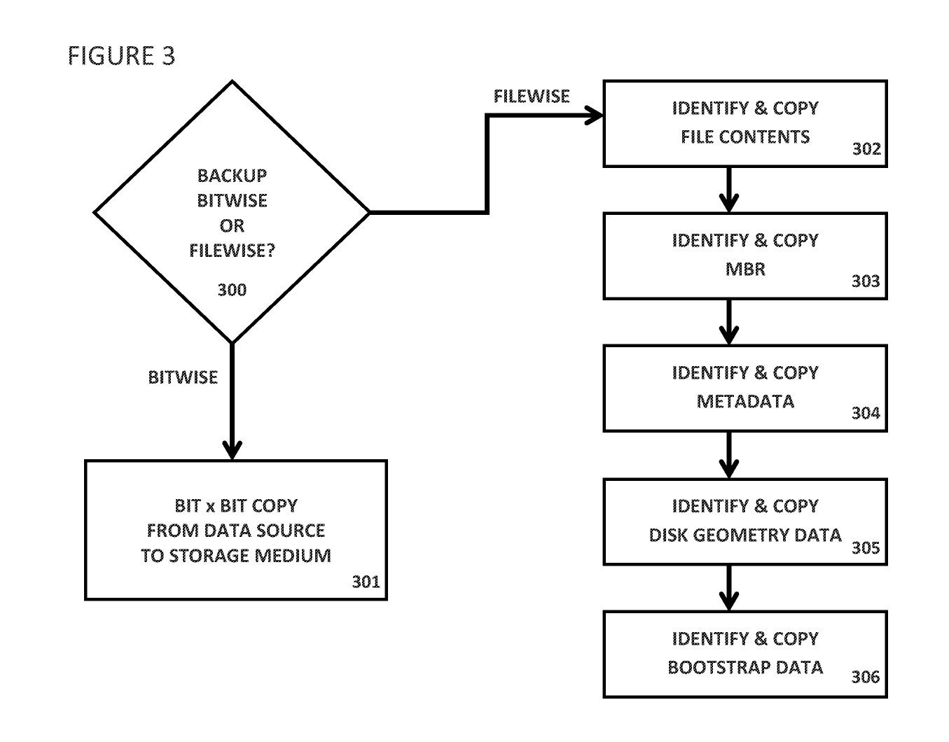

In step 201, a decision is made about whether to backup data from data source 101 to storage medium 102 or to restore data from storage medium 102 to data source 101. The decision to backup data may be made by the user or may be based on a programmed schedule or other automated process, whereas the decision to restore data is typically made at the user's request. If the data are to be backed up from data source 101 to storage medium 102, then in step 202, backup software resident on data source 101 (but optionally resident on storage medium 102 containing backed-up data or on another storage medium 102) is launched to initiate and control the backup process. Data are then backed up from data source 101 to storage medium 102 in step 203. The backup process within step 203 differs depending on whether the data are to be backed up in a file-by-file (or “filewise”) or bit-by-bit (or “bitwise”) manner. The process flows for data backed up in a file-by-file or bit-by-bit manner are illustrated in more detail in FIG. 3.

Referring to the process flow chart of FIG. 3, a decision is made in step 300 whether to backup the data using a bit-by-bit disk image process 301 or a file-by-file process of steps 302 through 306. This decision may be prompted and determined by user input or the backup device may be preconfigured to perform a backup by one of the two processes.

In the preferred embodiment, data on data source 101 are backed up using a file-by-file method whereby all the information in the hard disk drive including files, folders, partitions, master boot record (MBR), disk geometry, non-embedded metadata, and bootstrap data are backed up as logical entities (i.e., files) as indicated in FIG. 3. In step 302, each individual file on data source 101 is identified and its contents (whether data blocks are stored contiguously or in non-adjacent locations on data source 101) are retrieved and copied to storage medium 102 as one file with the data blocks stored in a contiguous sequence of sectors. Thus, the data files are defragmented during the backup process.

In step 303, a master boot record (MBR) on data source 101 is identified and copied to storage medium 102 so that it can later be used to recreate a root disk partition when restoring data. As is known in the art, the MBR contains a master boot code (within the first 466 bytes of the disk), a master partition table (within the next 64 bytes of the disk), and a boot code signature (in the remaining 2 bytes). The master boot code is the small piece of computer code that the Basic Input/Output System (BIOS) loads and executes to start the boot process. This code, when executed, transfers control to a boot program stored on the active partition to load the operating system. The master partition table is a second piece of code (commonly referred to as a table) which contains a description of the partitions that are contained on the hard disk. One of these partitions is marked as active, indicating that it is the data source to be used to continue the boot process. A hard disk drive uses the location of the MBR (always located at cylinder 0, head 0, and sector 1 (the first sector on the disk) within the first 512 bytes of the hard drive), as its consistent starting point. When a drive is powered up and the BIOS boots the machine, the drive looks at this first sector for instructions and information on how to proceed with the boot process and how to load the operating system. Thus, by backing up the MBR as described herein, the entire disk drive including any partitions that may have existed on the source disk drive) can be restored. This is in contrast to prior approaches to filewise backup of a data source which typically did not include the MBR-related information in the backup.

In step 304, non-embedded metadata on data source 101 are identified and copied to storage media 102. Methods to identify and access metadata are known in the art, as for example, in U.S. patent application Ser. No. 13/164,400 (Brunet et al.), herein incorporated by reference in its tire y.

In step 305, disk geometry data are identified on data source 101 and copied to storage medium 102. Hard disk drives are composed of one or more disks or platters on which data is stored. The “geometry” of a hard drive refers to the organization of data on these platters. Disk geometry determines how and where data is stored on the surface of each platter. Methods to identify and access disk geometry data are known in the art.

In step 306, boot-trap information is identified on data source 101 and copied to storage medium 102. Bootstrapping is a process by which the operating system of a computer is loaded from non-volatile memory (e.g. hard disk drive) into volatile memory (RAM). Generally, bootstrapping (shortened to “booting”) refers to a technique by which a simple computer program activates a more complicated system of programs. In the start-up process of a computer system, a small program such as BIOS initializes and tests that the hardware, peripherals and external memory devices are connected. It then loads a program from one of these devices and passes control to that device, thus allowing the loading of larger programs such as an operating system. The primary function of the BIOS is to load and start an operating system. Methods to identify and access bootstrap data are known in the art.

One of skill in the art will understand that data identified and copied from data source 101 to storage medium 102 need not proceed in a sequence identical to that presented in FIG. 3.

If the decision made at step 300 is to backup the data using a bitwise process, then in step 301, data are extracted from data source 101 bit-by-bit to create an identical disk image on storage media 102. The disk mage generated on storage media 102 through bit-by-bit copying step 301 produces a disk image on storage medium 102 that is as fragmented as the original data source 101 from which the bits forming the image came. If later restored bit-by-bit to a target data source 101, target data source 101 will likewise be as fragmented as original data source 101.

Referring back to FIG. 2, if the decision is made in step 201 to restore the data to data source 101, then the restore operation proceeds from step 204 through step 206. In optional step 204, data source 101 may be booted using a stripped-down operating system kernel (“OS kernel”) preferably resident on the storage medium. Booting data source 101 may be necessary if, for example and without limitation, data source 101 is to be restored after crashing. The “OS kernel” refers to any compact operating system, as for example and without limitation, based on open source Linux or bootable derivatives of Microsoft Windows (e.g., without limitation, the MS Windows Pre-installation Environment (Windows PE)). The stripped-down OS kernel preferably resides on storage medium 102, although one skilled in the art will recognize that the kernel may also reside on a medium different from storage medium 102.

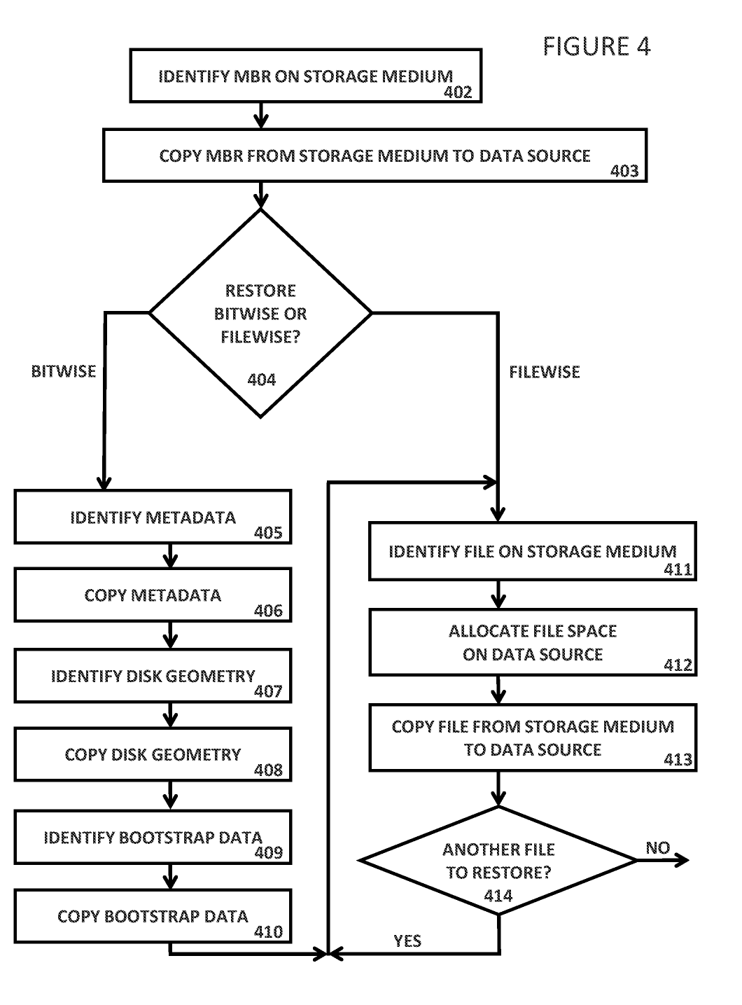

In step 205 of the restore process, backup software preferably resident on data source 101 (but optionally resident on storage medium 102) is launched to initiate and control the data restore process. In step 206, data files are restored by transferring them from storage medium 102 to target data source 101. Data are written as logical entities (files and folders) in contiguous sectors—that is, to a continuous sequence of sectors on the target hard disk drive of the data source. Because each file is written in contiguous sectors, the entire disk is automatically and necessarily defragmented. Restoring data stored as bitwise or filewise backups require different process steps, as will now be described with reference to FIG. 4.

In step 402, the MBR stored on storage medium 102 is identified and then, in step 403, copied from storage medium 102 to the first 512 bytes of target data source 101. Methods to identify and access the MBR in a file-by-file backup data set and in a bitwise backup data set are known in the art. During a file-by-file data backup, the MBR is saved to a text file. During the restore operation, the operating system accesses the text file on storage medium 102, extracts the MBR information, and then writes it to data source 101. For a bitwise data backup, the MBR is copied from the first 512 bytes of data source 101 and then written to the first 512 bytes of the backup data image on storage medium 102. During the restore operation, the operating system copies the first 512 bytes of storage medium 102 and writes those bytes to the first 512 bytes of data source 101.

In step 404, the software determines whether the data backup available for the restore is a bit-by-bite file-by-file backup. If the determination is that a bit-by-bit disk image backup on storage medium 102 is available to restore to target data source 101, the process proceeds from step 405 through step 414.

In step 405, non-embedded metadata on storage medium 102 are identified, and in step 406, space is allocated on target data source 101 and the non-embedded metadata are copied to that allocated space on target data source 101. Methods to identify and access non-embedded metadata in a file-by-file backup data set stored on a storage medium are known in the art.

In step 407, disk geometry data are identified on storage media 102, and in step 408, space is allocated on target data source 101 and the disk geometry data are copied to that allocated space on target data source 101. Methods to identify and access disk geometry data in a file-by-file backup data set stored on a storage medium are known in the art.

In step 409, bootstrap data are identified on storage medium 102, and in step 410, space is allocated on target data source 101 and the bootstrap data are copied to that allocated space on target data source 101. Methods to identify and access bootstrap data in a file-by-file backup data set stored on a storage medium are known in the art.

After metadata, disk geometry, and bootstrap data files have been copied from storage medium 102 to target data source 101 in steps 406, 408, and 410, an iterative process begins to identify the individual files on storage medium 102 and to copy them to locations on target data source 101 so that the restored data files are stored in contiguous sectors of target data source 101.

More specifically, in step 411, the location of each block of an individual file is identified. The data restore process identities each file on the disk image including all of the different data block components of the file. Once all of the data blocks for a given file have been identified, the total amount of free space that will need to be allocated on data source 101 can be determined. In step 412, the necessary allocation of contiguous free sectors is determined, requested from target data source 101, and assigned. In step 413, file data blocks are then copied from the disk image on storage medium 102 to the allocated contiguous sectors on target data source 101, thereby eliminating fragmentation of the file.

This process is repeated for each data file on the backup disk image. Because the data blocks for each file are written in contiguous sectors on the hard drive to which the data are being restored, the data are automatically defragmented as they are restored. The identification/allocation/copying of data files (steps 411, 412, and 413) is repeated for each identifiable data file in the disk image and continues until all data files on storage medium 102 have been copied to target data source 101. In step 414, once a determination is made that all files on storage medium 112 have been copied to data source 101, the restore process is terminated. One of skill in the art will understand that the restore process need not proceed in the same sequence as presented in FIG. 4.

Referring back to step 404, if the determination is made that a restore operation from a file-by-file backup on storage medium 102 is to be made rather than from a bit-by-bit disk image backup, the process proceeds from step 411 through step 414. It is to be understood that metadata, disk geometry data, and bootstrap data need not be separately identified and copied (steps 405 through 410) when restoring from a file-by-file backup because those classes of data were stored as files on storage medium 102. Instead, files containing metadata, disk geometry data, and bootstrap data are treated like any other data file during the restore process. Because the non-embedded metadata were backed up as a data file, and because the file folder is a logical construct, the operating system can access the metadata during the restore operation, determine how much space needs to be allocated to each file folder, allocate the necessary space, and write files within a folder to contiguous sectors of data source 101. This automatic defragmentation solves the problem of defragmentation due to file folder construction discussed above.

It is to be understood that, while a number of the examples are described herein as operations running on, for example, data source 101, the described operations can all be implemented in software stored in a computer readable storage medium for access as needed to run such software on the appropriate processing hardware of a server or user computing device.

The examples noted herein are only for illustrative purposes and there may be further implementation embodiments possible with a different set of components. While several embodiments are described, there is no intent to limit the disclosure to the embodiment or embodiments disclosed herein. On the contrary, the intent is to cover all alternatives, modifications, and equivalents obvious to the ones familiar with the art.

All aspects described herein are illustrative and not restrictive and may be embodied in other forms without departing from their spirit and essential characteristics.

It is to be understood that the exact sequences of the various operations described herein may be altered based on design choice so long as the underlying method and functionality is not altered in a way that would create an incorrect result or eliminate a needed dependency.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for defragmenting data files being restored to a data source from a set of backup data stored on a storage medium, the method comprising:
(a) launching on the data source a stripped-down operating system stored on the storage medium;
(b) running on the data source a data restore application;
(c) identifying a data file of the set of backup data stored on the storage medium using the data restore application running on the data source;
(d) allocating contiguous storage space on the data source using the stripped down operating system launched on the data source;
(e) copying the identified data file of the set of backup data to the allocated contiguous storage space on the data source; and
(f) repeating steps (c), (d), and (e) for any other data files of the set of backup data.

2. The method of claim 1 wherein the set of backup data stored on the storage medium comprises a bitwise disk image.

3. The method of claim 1 wherein the set of backup data stored on the storage medium is a file-by-file set of backup data.

4. The method of claim 1 wherein the data source comprises a solid-state medium, an optical device, or a hard disk drive.

5. method of claim 1 wherein the storage medium is a solid-state medium, an optical device, or a hard disk drive.

6. The method of claim 1 wherein the set of backup data stored on the storage medium comprises data from another data source.

7. The method of claim 6 wherein the other data source comprises a solid-state medium, an optical device, or a hard disk drive.

8. method of claim 1 wherein the step of running on the data source the data restore application further comprises accessing the data restore application from the storage medium.

9. The method of claim 1 wherein the step of running on the data source the data restore application further comprises accessing the data restore application from another storage medium.

10. The method of claim 1 further comprising the following before the step of launching a stripped-down operating system:
(a) identifying data files on the data source using a data file backup application running on the data source, and copying the identified data files from the data source to the storage medium;
(b) identifying a master boot record on the data source using the data file backup application running on the data source, and copying the identified master boot record from the data source to the storage medium;
(a) identifying metadata on the data source using the data file backup application running on the data source, and copying the identified metadata from the data source to the storage medium;
(b) identifying disk geometry data on the data source using the data file backup application running on the data source, and copying the identified geometry data from the data source to the storage medium; and
(c) identifying bootstrap data on the data source using the data file backup application running on the data source, and copying the identified bootstrap data from the data source to the storage medium.

11. The method of claim 1 further comprising the following before the step of identifying a data file:
(a) identifying a master boot record from the set of backup data stored on the storage medium using the data file restore application running on the data source, and copying the identified master boot record from the storage medium to the data source;
(b) identifying metadata from the set of backup data stored on the storage medium using the data file restore application running on the data source, and copying the identified metadata from the storage medium to the data source;
(c) identifying disk geometry data from the set of backup data stored on the storage medium using the data file restore application running on the data source, and copying the identified geometry data from the storage medium to the data source; and
(d) identifying bootstrap data from the set of backup data stored on the storage medium using the data file restore application running on the data source, and copying the identified bootstrap data from the storage medium to the data source.

12. A method for defragmenting data files being restored to a data source from a set of backup data stored on a storage medium, the method comprising:
(a) running on the data source a data restore application;
(b) identifying a master boot record from the set of backup data stored on the storage medium using the data file restore application running on the data source, and copying the identified master boot record from the storage medium to the data source;
(c) identifying metadata from the set of backup data stored on the storage medium using the data file restore application running on the data source, and copying the identified metadata from the storage medium to the data source;
(d) identifying disk geometry data from the set of backup data stored on the storage medium using the data file restore application running on the data source, and copying the identified geometry data from the storage medium to the data source;
(e) identifying bootstrap data from the set of backup data stored on the storage medium using the data file restore application running on the data source, and copying the identified bootstrap data from the storage medium to the data source;
(f) identifying a data file of the set of backup data stored on the storage medium using the data restore application running on the data source;
(g) allocating contiguous storage space on the data source;
(h) copying the identified data file of the set of backup data to the allocated contiguous storage space on the data source; and
(i) repeating steps (f), (g), and (h) for any other data files of the set of backup data.

13. The method of claim 12 wherein the set of backup data stored on the storage medium comprises a bitwise disk image.

14. The method of claim 12 wherein the set of backup data stored on the storage medium comprises data from another data source.

15. The method of claim 12 wherein the step of running on the data source the data restore application further comprises accessing the data restore application from the storage medium.

16. The method of claim 12 wherein the step of running on the data source the data restore application further comprises accessing the data restore application from another storage medium.

17. The method of claim 12 wherein the data source comprises a solid-state medium, an optical device, or a hard disk drive.

18. The method of claim 12 wherein the storage medium is a solid-state medium, an optical device, or a hard disk drive.

19. A non-transitory computer readable medium having stored thereupon computing instructions comprising:
(a) a code segment to launch on the data source a stripped down operating system stored on the storage medium;
(b) a code segment to run on the data source a data restore application stored on the storage medium;
(c) a code segment to identify a data file of the set of backup data stored on the storage medium using the data restore application running on the data source;
(d) a code segment to allocate contiguous storage space on the data source using the stripped down operating system launched on the data source;
(e) a code segment to copy the identified data file of the set of backup data to the allocated contiguous storage space on the data source; and
(f) a code segment to repeat steps (c), (d), and (e) for any other data files of the set of backup data.

20. The non-transitory computer readable medium of claim 19 further comprising the following:
(a) a code segment to identify data files on the data source using a data file backup application running on the data source, and to copy the identified data files from the data source to the storage medium;
(b) a code segment to identify a master boot record on the data source using the data file backup application running on the data source, and to copy the identified master boot record from the data source to the storage medium;
(c) a code segment to identify metadata on the data source using the data file backup application running on the data source, and to copy the identified metadata from the data source to the storage medium;
(d) a code segment to identify disk geometry data on the data source using the data file backup application running on the data source, and to copy the identified geometry data from the data source to the storage medium; and
(e) a code segment to identify bootstrap data on the data source using the data file backup application running on the data source, and to copy the identified bootstrap data from the data source to the storage medium.

21. The non-transitory computer readable medium of claim 19 further comprising the following:
(a) a code segment to identify a master boot record from the set of backup data stored on the storage medium using the data file restore application running on the data source, and a code segment to copy the identified master boot record from the storage medium to the data source;
(b) a code segment to identify metadata from the set of backup data stored on the storage medium using the data file restore application running on the data source, and a code segment to copy the identified metadata from the storage medium to the data source;
(c) a code segment to identify disk geometry data from the set of backup data stored on the storage medium using the data file restore application running on the data source, and a code segment to copy the identified geometry data from the storage medium to the data source; and
(d) a code segment to identify bootstrap data from the set of backup data stored on the storage medium using the data file restore application running on the data source, and a code segment to copy the identified bootstrap data from the storage medium to the data source.

22. A non-transitory computer readable medium having stored thereupon computing instructions comprising:
(a) a code segment to run on the data source a data restore application stored on the storage medium;
(b) a code segment to identify a master boot record from the set of backup data stored on the storage medium using the data file restore application running on the data source, and to copy the identified master boot record from the storage medium to the data source;
(c) a code segment to identify metadata from the set of backup data stored on the storage medium using the data file restore application running on the data source, and to copy the identified metadata from the storage medium to the data source;
(d) a code segment to identify disk geometry data from the set of backup data stored on the storage medium using the data file restore application running on the data source, and to copy the identified geometry data from the storage medium to the data source;
(e) a code segment to identify bootstrap data from the set of backup data stored on the storage medium using the data file restore application running on the data source, and to copy the identified bootstrap data from the storage medium to the data source;
(f) a code segment to identify a data file of the set of backup data stored on the storage medium using the data restore application running on the data source;
(g) a code segment to allocate contiguous storage space on the data source;
(h) a code segment to copy the identified data file of the set of backup data to the allocated contiguous storage space on the data source; and
(i) a code segment to repeat steps (f), (g), and (h) for any other data files of the set of backup data.
